(19) United States
(12) Patent Application Publication
(10) Pub. No.: US 2008/0099935 A1
(43) Pub. Date: May 1, 2008

(54) High-Precision Optical Surface Prepared by Sagging from a Masterpiece

(76) Inventors: Wilhelm Egle, Aalen (DE); Udo Dinger, Oberkochen (DE); Axel Matthes, Koenigsbronn (DE)

Correspondence Address: Walter A. Hackler;Patent Law Office, 2372 S.E. Bristol Street, Suite B, Newport Beach, CA, 92660-0755, US

(21) Appl. No.: 11/667,029

(22) PCT Filed: Nov. 8, 2005
(86) PCT No.: PCT/EP05/11894

§ 371 Date: Aug. 16, 2007

Related U.S. Application Data
(60) Provisional application No. 60/626,410, filed on Nov. 9, 2004.

(51) Int. Cl. B29D 11/00

(52) U.S. Cl. 264/1.7

(57) ABSTRACT

A method of making a high-precision optical surface which may be used either as a Wolter-type segment in an X-ray mirror system or in a collector of a EUVL system or as a spherical, aspherical, or free form normal or grazing incidence mirror in an EUVL system is prepared by sagging a thin flat glass sheet onto a masterpiece, in particular a mandrel, made from a temperature-resistant material, such as an alumina based ceramic or a keatite glass ceramic. The glass sheet is polished to the desired surface roughness (14), is positioned to an upper surface of the masterpiece (16), and is heated (18) to effect sagging onto the upper surface of the masterpiece for generating a shaped body. Thereafter, the shaped body is cooled and removed from the masterpiece, is mounted within a holder (22), is inspected for deviations from the specification (24) preferably using interferometric measurements, and is corrected for defects (26), preferably using ion beam figuring.

### BACKGROUND OF THE INVENTION

The invention is directed to the manufacture of a high-precision optical surface. More particularly the invention is directed to a method of making a high-precision optical surface, preferably intended for the use in the EUV and x-ray range, prepared by sagging from a masterpiece, in the following also called a mandrel. Such high-precision optical surfaces are commonly used as reflecting mirror elements e.g. designed in the so-called Wolter-type reflective surfaces (Hans Wolter, Ann. Ph. 6 (1952), 94 pp). However, in general, arbitrarily formed surfaces my be replicated by sagging.

In imaging Wolter-type telescopes the X-ray mirrors are operated at grazing incidence while taking advantage of the physical effect of total reflection. Typical x-ray energies are in the range of 1-10 keV. Usually a Wolter type configuration is provided by consecutively arranging a paraboloid or ellipsoid and a hyperboloid (T. Saha, Appl. Optics 26 (1987), 658 pp). In specific embodiments the ideal conic sections of revolution may be approximated by cones or modified by higher order corrections. Normally the mirror surfaces are configured as closed, rotationally symmetric mirror shells. Wolter-type X-ray telescopes of the next generation, such as a XEUS (X-ray Evolving Universe Spectroscopy Mission, ESA), or Constellation-X (NASA) will have considerably larger collecting areas than the telescopes currently in use that usually employ galvanically generated mirrors. E.g., the collecting surfaces of XEUS will be about two orders of magnitude larger than the collecting surface of the currently most sensitive telescope, XMM-Newton. Due to their large dimensions (diameters up to 10 m), these large observatories will most likely be built up from a large quantity of azimuthally segmented Wolter telescopes. To fully exploit such a sensitivity and to avoid astronomical source confusion, these new telescopes must also have a considerably high angular resolution of at least 5 arcsec or even two arcsec, calling for a high quality figure of the mirror shells, usually far in the sub-em range. To keep the light scattering background low, the micro-roughness of these mirrors may not exceed 0.5 nanometers rms.

The telescopes will have to be transported into space using suitable carrier rockets. This leads to very tight requirements with respect to size, mass, and stiffness of the optics. The mirrors must be extremely light and stiff at the same time. It has been found that up to now neither the conventional Ni-galvano-forming (also called Ni-electro-forming) and even less the former massive shell design from Zerodur® etc. can meet these demanding requirements.

Electroformed Ni-Wolter-optics are also utilized single shell as well as in multiply nested collectors for EUV (extreme ultraviolet) lithography systems operated in the wavelength range of appr. 10-20 nm (cf. EP1225481A2). These optics, which may utilize a single reflection, a two-reflection Wolter-type configuration or even multiple (>2) reflection configuration, collect the light of suitable high power EUV-sources, such as plasma discharge sources or laser plasma sources. These sources are becoming more and more powerful and part of the emitted radiation is absorbed and heats the mirror shells. Effective convection cooling is not possible since these systems are operated in vacuum. Thus the heat can only be transported by heat conduction and radiative cooling. Consequently thermally induced problems are increasing due to more and more heat generation. Besides thermally induced deformations, the heating of the mirror segments up to several hundred degrees Celsius may drive the mirrors beyond the stable temperature operating range of nickel. However, massive mirror segments from more temperature resistant materials are difficult to achieve, due to geometrical restrictions.

EUVL systems also make use of mirrors with more general grazing or normal incidence geometries (cf. U.S. Pat. No. 6,438,199B1, EP1225481A2). In any case, a microroughness in the order of a few Angstroms is required for proper reflectivities and stray light characteristics in the x-ray range. The classical way of figuring and finishing to the specified roughness is in general cumbersome and costly.

From US-application publication number US2004/0107731 A1 a method for the forming of glass or glass ceramics is known which comprises the preparation of a keatite glass ceramics mandrel or mold from which shaped bodies can be prepared from blank glass sheets by sagging under gravity force at a temperature above the glass transition temperature of the blank sheets. The blank glass sheet is provided at a suitable thickness and is usually polished on both sides to reach a small variation in thickness of the glass and a flat surface. The blank glass sheet is placed on top of the keatite mandrel and is heated together therewith according to a heating program up to a temperature above the transition temperature of the glass body to induce sagging of the glass sheet onto the surface of the mandrel.

It has been tried to sag Borofloat® substrates onto keatite mandrels and to obtain the required precision and shape by subsequent computer controlled polishing (confer Ghigo et al., Proc. SPIE. 5168 (2003), 181 pp., Doehring et al., ibid 146 pp.).

However, the sagging process does not yield sufficiently precise figure (low frequency, i.e. with typical structure sizes larger than approx. 1 cm). Typical shape precisions of 10 μm to 100 μm were reached, so that considerable corrective polishing steps are necessary to meet the requirements of the optical system. These corrective polishing steps, however, lead to the deterioration of the micro-roughness of the substrates. This has to be corrected again in a super polishing step which, however, leads to considerable forces onto the thin substrates. All in all, the complete process is extremely tedious, does not yield consistent results and is thus not applicable to a large scale production.

### SUMMARY OF THE INVENTION

In view of this, it is a first object of the invention to disclose a method of making a high-precision optical surface overcoming the draw-backs of the prior art.

It is a second object of the invention to disclose a method of making a high-precision optical surface that can be employed in a large scale production process and that can ensure consistently precise surface characteristics with respect to figure and surface roughness.

It is a third object of the invention to disclose a method of making a high-precision optical surface that allows the production of very thin and light-weight surfaces consisting of glass or glass ceramics having a surface roughness of 0.5 nanometers rms or better.

It is a fourth object of the invention to disclose a method of making mirror segments for a Wolter-type X-ray telescope suitable for employment in the orbit.

It is a fifth object of the invention to provide reflective mirror segments that can be used as components for a collector in high-power EUVL systems which are up to 600° C. thermally stable under gravitational loads.

It is a sixth object of the invention to provide a reflective grazing or normal incidence mirror that can be used as component in high power EUVL systems.

These and other objects of the invention are reached by a method comprising the following steps:
(a) preparing a masterpiece, in particular a mandrel, from a temperature-resistant material having an upper shaped surface to be replicated;
(b) preparing a flat glass sheet at a desired thickness and surface roughness;
(c) positioning the flat sheet onto the upper shaped surface of the masterpiece;
(d) heating the glass sheet and the masterpiece to effect sagging of the flat sheet onto the upper shaped surface of the masterpiece for generating a shaped body;
(e) cooling the shaped body and removing the shaped body from the masterpiece;
(f) mounting the shaped body within a holder;
(g) inspecting a surface of the shaped body; and
(h) correcting figure deviations detected during inspection preferably by ion beam figuring (IBF).

According to the invention, a reflective element is disclosed comprising a shaped body having a contour corresponding to a Wolter-type optic, the shaped body consisting of a thin sheet having a thickness of less than 2 millimeters; a reflective coating applied to a surface of the shaped body; wherein the shaped body has a surface roughness of 0.5 nanometers rms at the most and preferably 0.3 nm rms at the most. Such reflective elements are preferably used as monolithic segments of X-ray mirrors in telescopes or as segments of a light collector in an EUVL system.

For EUVL reflective elements, arbitrary symmetric (spherical, aspherical) or free form surfaces may be replicated, where the constraint to thickness below 2 mm is not mandatory, since slumping also works with glass sheets of up to approximately 1 cm in this case. The reflective coating is preferably a reflective multilayer coating suitable for the reflection of EUV-radiation at normal incidence, or a single layer in the case of a grazing incidence mirror. Such elements are preferably used in illumination systems or projection objectives of EUVL projection exposure apparatuses.

It was found that the figure precision can be greatly enhanced by mounting the shaped body after sagging first in a holder and inspecting the surface of the shaped body and correcting slight figure deviations detected thereby while keeping the shaped body fixed in the holder. Interferometric measurements or fringe reflection techniques (cf. e.g. http://www.vialux.de/) can be employed for inspecting the shaped bodies replicated from the mandrel. Interferometric measurements or fringe reflection techniques avoid additional deformations usually caused by contacting measurements.

The method according to the invention has the additional advantage of avoiding any epoxy synthetics that serve as intermediate layers in prior art epoxy-replication processes. These epoxy layers may become unstable or deform the mirrors due to shrinkage at the cryo-temperatures faced by operation in space.

The invention will now be more fully described with respect to preferred embodiments with reference to the drawings which are of merely exemplary nature and which shall not be regarded as restrictive to the scope of the invention in any way. In the drawings show:

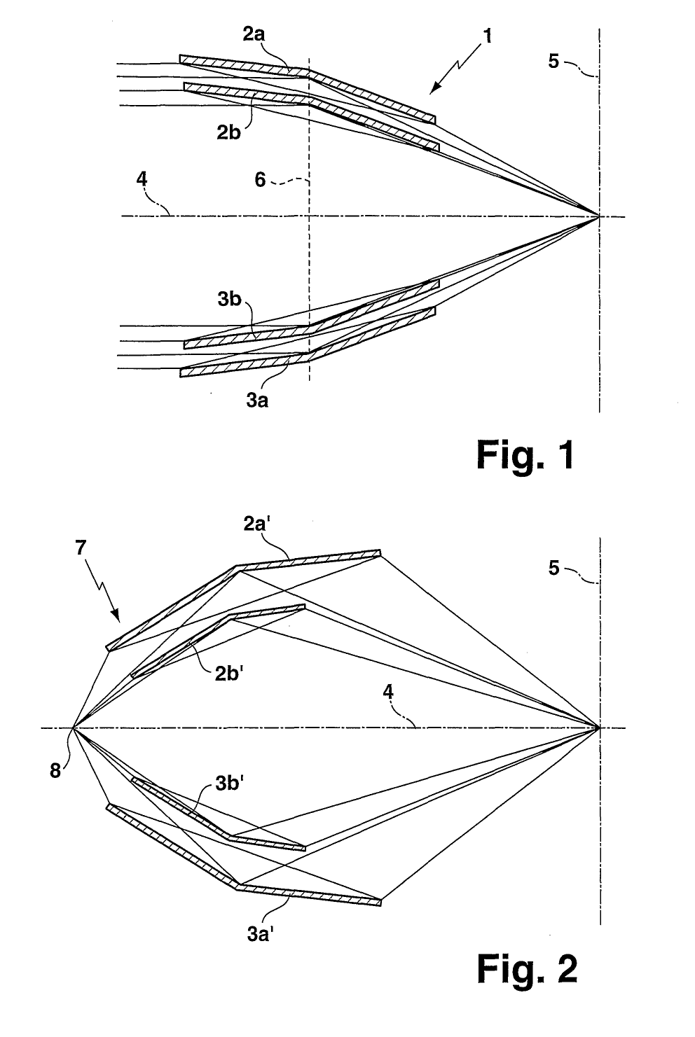

FIG. 1 a sketch of a Wolter type I telescope;

FIG. 2 a simplified representation of a Wolter type I based collector used for collecting the light in an EUV-lithography (EUVL) system;

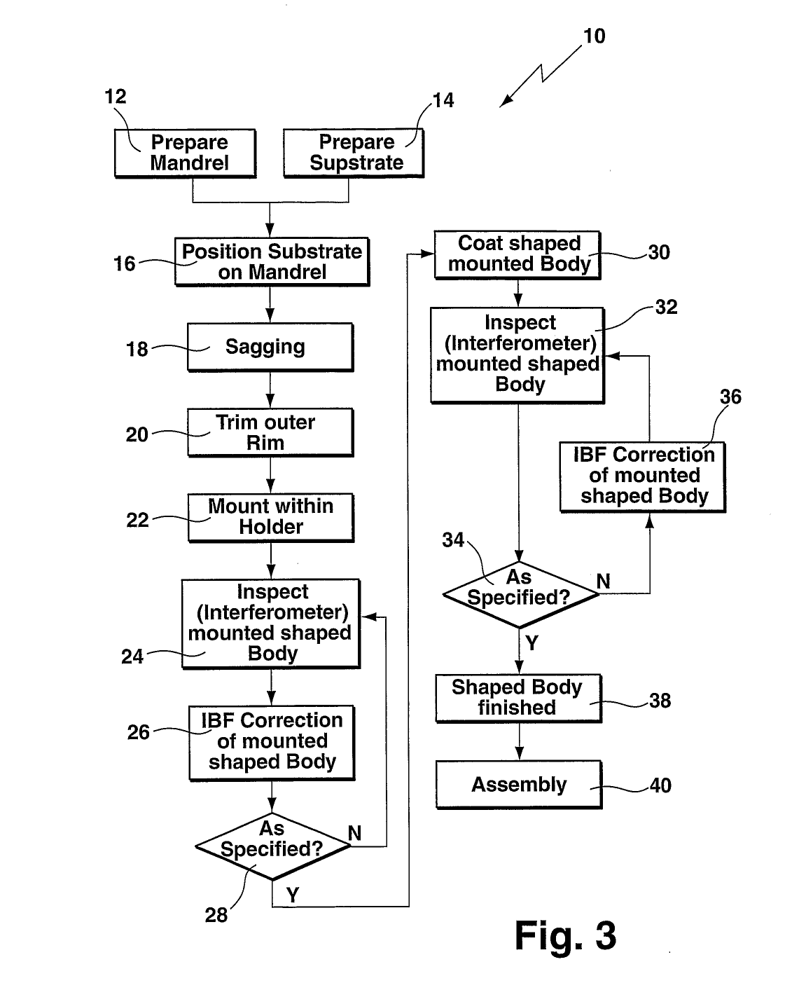

FIG. 3 a flow chart of the main steps employed according to the invention for producing shaped reflective elements;

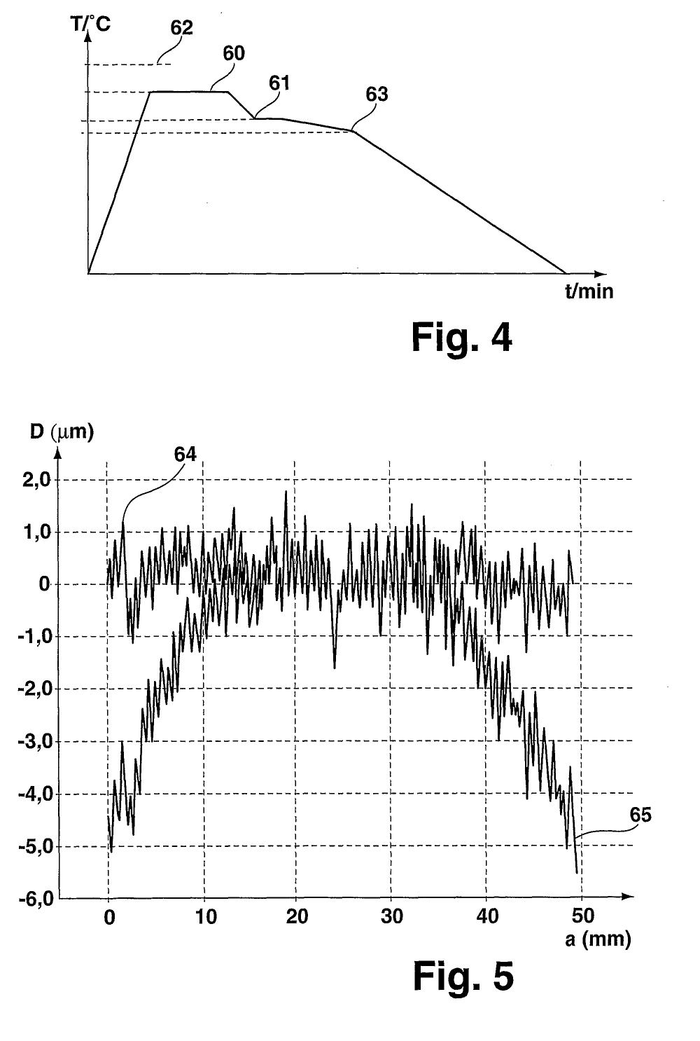

FIG. 4 a schematic representation of a temperature profile utilized for sagging;

FIG. 5 the figure deviations obtained with direct and indirect sagging of Borofloat® glass onto an alumina based ceramics mandrel;

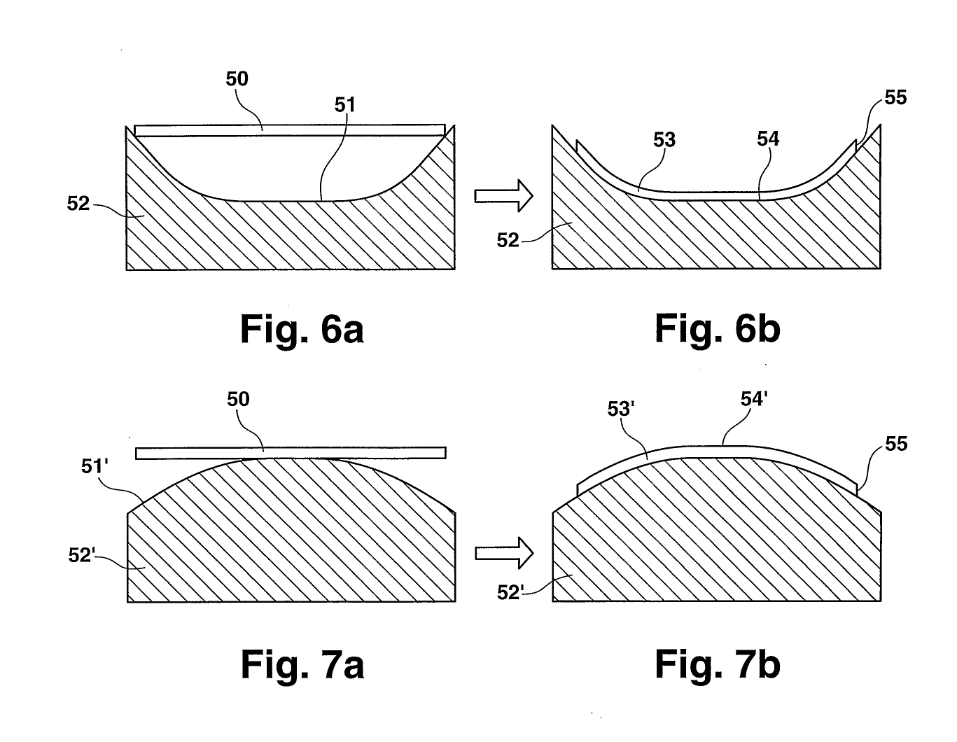

FIG. 6 a sketch of a glass sheet and a mandrel with a concave upper surface before (FIG. 6a) and after the sagging (FIG. 6b);

FIG. 7 the sketch of FIG. 6 with a mandrel having a convex upper surface; and

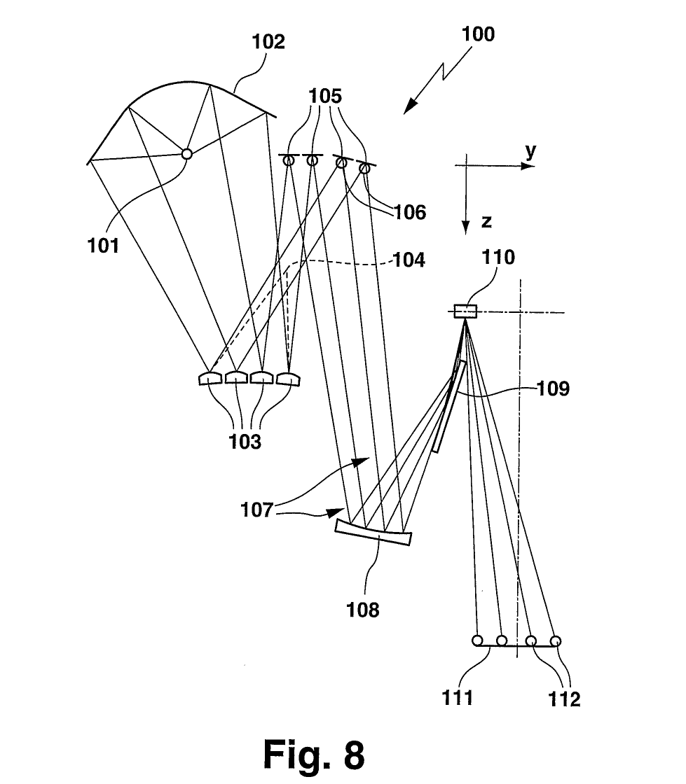

FIG. 8 a schematic view of an illumination system for an EUVL projection exposure apparatus with a plurality of embodiments of EUVL reflective elements according to the invention.

According to the invention a method of making a high-precision optical surface is disclosed which is particularly suited as a mirror segment for X-ray Wolter-type telescopes or as a collector used in EUV lithography systems. Very thin glass sheets with a thickness of less than 2 mm are sagged onto mandrels at a temperature above the glass transition temperature and below the glass softening point during the process of which the x-ray compatible surface roughness of the glass sheet is maintained while the contour of the mandrel is replicated to the shaped glass body. If superpolished mandrels are used, the surface roughness of the directly replicated surface may even be improved. Thicker glass sheets with a thickness up to 10 mm may be used in EUVL systems for mirror components which are not nested. After sagging the shaped bodies are inspected and corrected for deviations from a given standard. Preferably, correction is performed by ion beam figuring.

In FIG. 3 a flow chart depicting the basic steps of the method 10 according to the invention is shown.

First of all, a temperature resistant masterpiece, in the following referred to as a mandrel or mold from which a large number of shaped bodies can be replicated is prepared in a first step 12. The mandrel may represent a positive or a negative shape of the optical surface to be produced. Depending on the material from which the mandrel is made and from which the substrate is made, a particular shape correction must be provided which compensates for the differences in thermal expansion between the mandrel and the substrate.

Suitable glass sheets are prepared in a second step 14 which may consist of float glass, display glass or other thin glass substrates which typically have a thickness between 0.1 and 1 mm in case of production of nested mirror elements and of up to 10 mm in case of producing non-nested ones. The roughness of the glass substrate should correspond to the micro-roughness that shall be obtained on the final optical surface and shall therefore preferably be in the range of 0.5 nanometers rms or below. The sub 0.5 nm rms-roughness is usually provided by the glass production process already. A subsequent superpolishing step on the still flat sheets can be applied to remove residual variations in the sheet thickness, while conserving or improving the x-ray compatible roughness. To enable this the sheets are e.g. brought in optical contact with a thicker flat sheet prior to the polishing with standard procedures.

In case the final optical surfaces shall operate at temperature conditions which vary to a large extent (e.g. application in an EUVL system) the substrate material should have a thermal expansion as low as possible. Borosilicate glasses may be used that match closely with the thermal expansion of keatite glass ceramic mandrels supplied for example by Schott Glas AG. Other materials having an even smaller coefficient of thermal expansion may also be contemplated, such as lithium-aluminosilicate glasses (LAS-glasses), quartz glasses, ULE®. However, a limitation is always set by the temperature resistance of the mandrel which may be up to 1000° C., if keatite glass ceramic mandrels are used or even higher, if alumina based mandrels are used. Thus, in particular, LAS-glasses may be of interest, such as Ceran® based glasses which may be converted to glass ceramics prior or after the sagging step. Firepolished glass sheets, e.g. D263T® from Schott DESAG AG, were shown to have microroughness values in compliance with the requirements of x-ray optics. Few-Angstrom rms values can be obtained as well in the so-called mid spatial frequency roughness (MSFR), as measured with microinterferometers, covering spatial wavelengths in between 1 μm and 1 mm, as well as for the high spatial frequency roughness (HSFR), measured by an atomic force microscope in the spatial wavelength range in between appr. 20 nm and 1 μm.

After preparation of a suitable glass or glass ceramic substrate in the form of a flat glass sheet 50 (see FIG. 6a), the glass sheet 50 is positioned in a third step 16 on an upper concave surface 51 of a mandrel 52 and is then placed in a suitable sagging furnace (not shown).

The combination of the mandrel 52 and the glass sheet 50 is then heated in a fourth step 18 to a precisely defined sagging temperature which is close to but somewhat below the softening point of the glass or glass ceramic utilized (typically in the range between 500° C. and 700° C.). The substrate is kept at this temperature for a predefined time and is then cooled to room temperature according to a specific temperature program keeping into account the glass specific annealing and strain points. When the process is performed in a suitable way, shape replication deviations may be kept to the order of one micrometer and the substrate will not stick to the mandrel 52, thus forming a shaped body 53 (cf. FIG. 6b) having a surface roughness corresponding to that of the glass sheet 50. The mandrel 52 of FIG. 6 is a negative mandrel, such that a final optical surface 54 is provided directly on the sagged side of the shaped body 53 facing the mandrel 52 (so-called direct sagging). In contrast to this, the mandrel 52′ shown in FIGS. 7a and 7b having a convex upper surface 51′ is used as a positive mandrel, such that the final optical surface 54′ is generated on the side of the shaped body 53′ facing away from the mandrel 52′ and not getting in contact therewith (so-called indirect sagging). In the terminology of the above example the final optical surface has a convex shape. In the case of the replication of a concave or freeform surfaces the terms direct and indirect as well as positive and negative mandrel have to be adapted accordingly, as will be appreciated by the person skilled in the art. Depending on the sagging conditions and the viscosity characteristics of the substrate, different requirements must be met for the roughness of the mandrel 52, 52′: between finely ground and superpolished. The sagging process may preferably aided by application of a vacuum to a lower surface of the mandrel 52, 52′ provided that the latter is made of a porous ceramic material or other suitable substance being transmissive for vacuum. The application of the vacuum helps sucking the glass sheet 50 onto the mandrel. In the case of a Wolter-type replication, the mandrels preferably are configured as monolithic Wolter type I segments (not shown), i.e. each segment carries e.g. a parabola/hyperbola combination rigidly connected and correctly aligned. It has been found to be very advantageous to provide a monolithic Wolter-type shape, since a later assembly of individual very thin parabola and hyperbola segments is very difficult and may easily lead to significant shadow effects.

Thereafter, an outer rim 55 of the sagged shaped bodies 53, 53′ may be trimmed in a suitable way to the desired dimensions in a further step 20.

Subsequently, the shaped bodies are mounted in suitable holders in an almost stress-free configuration in a subsequent step 22.

Thereafter, the shaped bodies are inspected in a step 24 using interferometric measurements while being mounted in their respective holders. Thereby, additional deformations caused by pressure forces commonly occurring with contact measurements are avoided. The null correction wave front pattern for the inspection of the usually aspherical off-axis shape of the final mirror segments used in Wolter-type reflectors are preferably generated by a computer generated hologram (CGH), possibly at the aid of refractive elements (e.g. cylinder lenses) or maybe merely provided by refractive elements. To avoid disturbing interferences by the superposition of the front and backside reflections of the shaped bodies, the interferometer is preferably operated with short coherent light (so-called white light interferometer). Any deformations caused by mounting within the holder can be detected and corrected during this measurement. Using “white light” interferometers operated with short coherence light sources, sheets down to a thickness of about 100 μm or even thinner may be inspected. However, care has to be taken of the strong dispersion, especially when using CGHs.

In a following step 26 the surface defects detected in step 24 are corrected without removing the shaped body from its holder. The preferred correction method is ion beam figuring (IBF) which has the advantage to exert only very small forces to the shaped body and to largely keep the micro-roughness of all optically relevant materials. IBF is a merely relative process, i.e. reversible deformations induced by stress or gravitation during mounting in the arrangement are not relevant for meeting the treatment objective.

In step 28 it is checked, whether the shaped body corresponds to the specification. If not, steps 24 and 26 may be repeated several times.

If the shaped body is according to the specification, the shaped body which is still mounted in its holder, may be placed in a suitable coating facility and may be coated in step 30 with a suitable single reflecting surface (e.g. Au, Pd, Ni, Ir, Pt, Rh, Ru, Mo), in particular when the shaped and coated body is used as a grazing incidence mirror. Naturally, the coating should be performed by a suitable process, such as CVD or PVD to obtain a coating as stress-free as possible. Also multilayer coatings as e.g. the Mo/Si-based multilayers or the more general coating systems as disclosed e.g. in DE 100 11 547 C2, or EP 1065 532 B1 for the EUVL wavelengths in between 10-15 nm or state of the art multilayer-coatings for hard x-rays are possible, yielding high reflectance also for radiation at normal incidence. Such multilayer coatings normally consist of a stack of alternating layers of a first and second material, each with a different real refractive index. Suitable candidates for the first material are e.g. Mo, Ru, or Rh; for the second material e.g. Si, Be, P, Sr, Rb or RbCl. Additional layers may be present in these multilayer systems for improvement of reflectance, as well as a suitable capping layer consisting of an inert material, as will be appreciated by a person skilled in the art.

Subsequently the coated shaped body which forms a reflective element is inspected in step 32, again using interferometry. Surface roughness is checked using interference microscopes and atomic force microscopes.

If in the following step 34 it is detected that the reflective element meets the specification, then the shaped bodies are finished (step 38). Otherwise, the IBF correction steps 36 and subsequent inspection steps 32 may be repeated. As the case may be, additional coating steps 30 may also be performed for meeting the specification.

Finally the reflective element is incorporated into an optical device such as a telescope, in a final step 40.

Using this method extremely precise and very light weight temperature resistant and stiff reflective optical elements may be produced on an industrial scale which may be used e.g. in Wolter type telescopes or as collectors in EUVL systems. Other—possibly thicker—components for EUVL systems which are not nested can be produced by this method in a very cost-effective way on an industrial scale.

FIG. 1 shows a sketch of an imaging Wolter-type I telescope 1 for focusing beams of incident X-ray radiation into a focal plane 5 arranged perpendicular to an optical axis 4 of the telescope 1. For this purpose, the telescope 1 comprises a plurality of concentrically arranged, rotationally symmetric nested monolithic Wolter-type X-ray mirror shells which are azimuthally segmented. A first and second monolithic Wolter-type mirror segment 2a, 3a of a first mirror shell and a first and second Wolter-type mirror segment 2b, 3b of a second, more inwardly arranged mirror shell are shown in FIG. 1. The mirror segments 2a to 3b are produced according to the method described above and operated at grazing incidence while taking advantage of the physical effect of total reflection. Consequently, only a single-layer reflective coating for hard x-rays has to be applied to the surfaces of the shaped bodies forming the mirror segments 2a to 3b. For improvement of the spectral response of the mirrors also more complex multilayer coatings may be applied. In the configuration of FIG. 1, each mirror segment 2a to 3b has a first, hyperbolic section (remote from the focal plane 5) and a second, parabolic section (close to the focal plane 5), the first and second sections being separated by a sharp bend of the mirror segments 2a to 3b in a plane 6 parallel to the focal plane 5. For the nested configuration of FIG. 1, it is mandatory that the thickness of the mirror segments 2a to 3b is less than 2 mm.

FIG. 2 shows a light collector 7 which may be used in a EUVL system for focusing light emitted in form of a beam cone from a EUV light source 8, e.g. a plasma source, to a focal spot in a focal plane 5. The collector 7 has a structure comparable to the telescope 1 of FIG. 1, in that it is equipped with a plurality of concentrically arranged grazing incidence mirror shells. However, the collector 7 is constructed for collecting EUV radiation instead of hard x-rays, thus the grazing angles allowing sufficient reflectivity can be chosen somewhat larger than in the case of hard x-rays. For the mirror segments 2a′ to 3b′ of the collector 7, single material as well as multilayer reflective coatings have to be used, such as the ones described in greater detail above. The grazing-incidence mirror segments 2a′ to 3b′ of the collector 7 have a first, hyperbolic section close to the light source 8 and a second, elliptic section close to the focal plane 5, which are separated by a sharp bend in the mirror segments 2a′ to 3b′.

Another application of reflective elements produced according to the method described above is represented in FIG. 8, showing a purely reflective illumination system 100 of an EUVL projection exposure apparatus in a schematically view, which is described in greater detail in U.S. Pat. No. 6,438,199 B1. The illumination system 100 is designed for providing any desired illumination distribution in a plane while satisfying the requirements with reference to uniformity and telecentricity. In the illumination system 100, a beam cone of a EUV light source 101 (typically a plasma source) is collected by an ellipsoidal collector mirror 102 and is directed to a plate with field raster elements 103. The collector mirror 102 is designed to generate an image 104 of the light source 101 between the plate with the field raster elements 103 and a plate with pupil raster elements 105 if the plate with the field raster elements 103 would be a planar mirror as indicated by the dashes lines. The convex field raster elements 103 are designed to generate point-like secondary light sources 106 at the pupil raster elements 105, since the light source 101 is also point-like. Therefore, the pupil raster elements 105 are designed as planar mirrors. The pupil raster elements 105 are tilted to superimpose the images of the field raster elements 103 together with a field lens 107 formed as a first and second field mirror 108, 109 (described in greater detail below) in a field 110 to be illuminated. Both, the field raster elements 103 and the pupil raster elements 105 are tilted. Therefore the assignment between the field raster elements 103 and the pupil raster elements 105 is defined by the user. The concave field mirror 108 images the secondary light sources 106 into the exit pupil 111 of the illumination system 100 forming tertiary light sources 112, wherein the convex field mirror 109 being arranged at grazing incidence transforms the rectangular images of the rectangular field raster elements 103 into arc-shaped images.

The first EUVL field mirror 108 is built up from a concave shaped body which is covered with a reflective multilayer coating suitable for the reflection of EUV radiation at normal incidence as described e.g. in EP 1 065 532 B1 or DE 100 11 547 C2, both of which are incorporated herein by reference in their entirety. Between the multilayer coating and the surface of the shaped body, a suitable bonding layer is applied, as will be appreciated by the person skilled in the art. The second EUVL field mirror 109 has a convex shaped body and is used at grazing incidence such that a single reflective coating layer is sufficient, which is carried directly by the shaped body without any intermediate material. Both field mirrors 108, 109 are produced according to the method described in connection with FIG. 3 and have shaped bodies made of glasses suited for sagging with a thickness below 1 cm. Also, the collecting mirror 102 as well as the field raster elements 103 and the pupil raster elements 105 are produced by the inventive method.

### EXAMPLES

Various sagging tests were performed using different materials as a mandrel and also as a substrate. Alumina based ceramics, keatite glass ceramic (provided by Schott DESAG AG) and Zerodur® glass ceramic (provided by Schott Glas AG), stainless steel, SiC, Si₃N₄ were tested as a mandrel material. Substrate materials that are closely matched to the thermal expansion behavior of these mandrels are primarily borosilicate glasses.

The borosilicate glass D263 (provided by Schott) has a coefficient of thermal expansion (about 7·10⁻⁶/K between 20 and 300° C.) matching an alumina based ceramic. Borofloat® (also provided by Schott) having a lower coefficient of thermal expansion (about 3·10⁻⁶/K) can be used together with keatite mandrels (about 2·10⁻⁶/K). Zerodur® has a coefficient of thermal expansion (on the order of 10⁻⁷/K) which is considerably smaller than the one of all other materials in the relevant temperature range up to 600° C.

To effect sagging, the temperature was initially adjusted to the glass specific sagging temperature 60 above the annealing point 61, but still below the softening point 62 of the respective glass (cf. FIG. 4 depicting the temperature profile in principle). After a preset holding time at the sagging temperature 60, the glass was cooled according to a preset temperature profile down to the annealing point 60, then to the strain point 63 and finally down to room temperature. The respective temperatures (strain point 63, annealing point 61, softening point 62, glass transition temperature etc.) are well known and are defined by the respective standardized viscosity of the glasses at these points.

Apart from corrections for focus errors, the aspheric profiles of alumina based mandrels could be replicated very precisely with deviations on the order of a few micrometers (confer FIG. 5). During testing measurements were still performed using a contact sensor (Tallysurf instrument).

In FIG. 5 the results of direct sagging (upper curve 64) and indirect sagging (lower curve 65) of Borofloat® glass sheets of 1 millimeter thickness onto an alumina based mandrel are depicted. The profiles were not biased with respect to the differences in the coefficients of thermal expansion of the mandrel and the substrate. The specific curvature of the replica can be influenced by the cooling rates. The roughness D of the displayed profiles (in dependence of position a) does not stem from the substrate but originates mainly from the mandrel profile which was subtracted in both cases.

The viscosity of the glass at the sagging temperature determines to a large extent which local frequencies of the shape roughness are replicated onto the shaped body. The lower the viscosity, i.e. the higher the temperature, the more high frequent structures can be replicated at a given modulation transfer.

Therefrom, the following replication scenarios may be derived:
a) Direct sagging onto a rough mandrel. In this case the sagging temperature should be kept as low as possible to avoid a deterioration of the roughness of the substrate.
b) Indirect sagging onto a rough mandrel. In this case the temperature may possibly be higher than in the first case, since surface roughness of the mandrel is not transferred to the backside.
c) Direct sagging onto super polished mandrel at high temperature. In this case the surface roughness of the mandrel is directly transferred onto the substrate. Possibly the surface roughness can be even improved thereby. Also possibly in such a process already precoated substrates may be sagged. If possible, this would be the ideal process, for time and cost saving considerations.
d) Indirect sagging onto super polished mandrel.

1-58. (canceled)

59. A method of making a high-precision optical surface comprising the following steps:
(a) preparing a masterpiece from a temperature-resistant material having an upper shaped surface to be replicated;
(b) preparing a flat glass sheet at a desired thickness and surface roughness;
(c) positioning said flat glass sheet onto said upper shaped surface of said masterpiece;
(d) heating said glass sheet and said masterpiece to effect sagging of said flat glass sheet onto said upper shaped surface of said masterpiece for generating a shaped body;
(e) cooling said shaped body and removing said shaped body from said masterpiece;
(f) mounting said shaped body within a holder;
(g) inspecting a surface of said shaped body; and
(h) correcting defects detected during inspection by ion beam figuring (IBF).

60. The method according to claim 59, wherein said masterpiece is made from a material selected from the group formed by an alumina based ceramic, a keatite glass ceramic, the glass ceramic Zerodur®, steel, SiC, WC and Si₃N₄.

61. The method according to claim 59, wherein said masterpiece is made from a porous material and said sagging step (d) comprises applying a vacuum to a surface of said masterpiece for sucking said glass sheet onto said masterpiece.

62. The method according to claim 59, wherein said flat glass sheet is made of a material selected from the group formed by a borosilicate glass, a lithium-aluminosilicate glass, a lithium-aluminosilicate glass ceramic, quartz glass and ULE®.

63. The method according to claim 59, wherein said inspecting step (g) is performed by interferometric measurement.

64. The method according to claim 63, wherein a test pattern is generated from a computer generated hologram.

65. The method according to claim 63, wherein a test pattern is projected at the aid of refractive optics.

66. The method according to claim 59, wherein a correction is made for deformations caused by mounting said shaped glass body in said holder.

67. The method according to claim 59, wherein said inspecting step (g) is performed by fringe reflection.

68. The method according to claim 59, wherein said steps (g) and (h) are repeated until a given tolerance is met.

69. The method according to claim 59, wherein said shaped body is coated with a reflective coating.

70. The method according to claim 69, wherein said shaped body is inspected after coating and compared to a given standard.

71. The method according to claim 70, wherein said shaped and coated body is corrected by ion beam figuring (IBF), if any deviations from the given standard exceed a given threshold value.

72. The method according to claim 59, wherein said shaped body comprises an outer rim which is encompassed by said holder when mounting in said holder.

73. The method according to claim 59, wherein said shaped body is trimmed to a given size before mounting in said holder.

74. The method according claim 59, wherein said sagging step (d) is performed above the glass transition temperature close to the softening temperature of said glass sheet.

75. The method according to claim 69, wherein a material selected from the group formed by Au, Pd, Ni, Ir, Pt, Rh, Ru, Mo and alloys thereof is used for coating said shaped body.

76. The method according to claim 69, wherein a coating comprising more than one layer is applied to said shaped body (53, 53′).

77. The method according to claim 69, wherein said shaped body is coated with a reflective multilayer coating suitable for the reflection of EUV- or x-ray radiation.

78. The method according to claim 77, wherein a material of at least one layer of said multilayer coating is selected from the group consisting of Mo, Ru, Rh, Si, Be, P, Sr, Rb, and RbCl.

79. The method according to claim 59, wherein said masterpiece is configured in the shape of a monolithic Wolter-type segment of an X-ray mirror.

80. The method according to claim 59, wherein said masterpiece is configured in the shape of a monolithic Wolter-type segment of a light collector of an EUVL system.

81. The method according to claim 59, wherein said masterpiece is configured in the shape of a spherical, aspherical, or free form grazing incidence mirror.

82. The method according to claim 59, wherein said masterpiece is configured in the shape of a spherical, aspherical, or free form normal incidence mirror.

83. The method according to claim 59, wherein said sheet has a thickness between 0.05 and 2 millimeters.

84. The method according to claim 59, wherein said sheet has a thickness between 0.1 and 1 millimeter.

85. The method according to claim 59, wherein said sheet has a thickness between 1 and 10 millimeters.

86. The method according to claim 63, wherein said inspecting step (g) is performed using a white light interferometer.

87. The method according to claim 59, wherein at least one surface of said flat sheet is polished.

88. The method according to claim 87, wherein said surface is polished to a surface roughness of less than 1 nanometers rms, preferably below 0.5 nm rms, more preferably below 0.3 nm rms.

89. The method according to claim 59, wherein in step (c) a floated or fire polished glass sheet having a low surface roughness is positioned on said upper surface of said masterpiece.

90. The method according to claim 59, wherein thickness variations of the glass sheet are corrected by polishing prior to sagging.
